(19) United States
(12) Patent Application Publication
(10) Pub. No.: US 2011/0201298 A1
(43) Pub. Date: Aug. 18, 2011

(54) Substitution of a telephone land line based home alarm system with a cell phone connection based system

(76) Inventor: Jerome Gelover, Lake Worth, FL (US)

(21) Appl. No.: 12/658,913

(22) Filed: Feb. 18, 2010

(51) Int. Cl. H04M 11/04

(52) U.S. Cl. 455/404.1

(57) ABSTRACT

The purpose of the invention is to remove the need for a telephone landline and replace it with a cell phone connection for the purpose of signaling and reporting an alarm signal sequence to the alarm monitoring company in the event of an alarm triggering event. The invention uses a unique way of interconnecting standard available components to accomplish the removal of the standard telephone line and replacement with a cell phone.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Commercial home alarm systems such as the XP-600, (Appendix A, FIG. 2) exist in many homes such as the Bellaggio retirement community in Lake Worth, Flor., where the invention has been conceived, tested and installed.

These systems require an active telephone company land line or an active internet connection in order to report an Alarm generated by the home alarm system. In many cases the telephone line exists solely for the purpose of providing a conduit for the alarm system as many households use cell phones instead of landline telephones. Further, the land line must remain active even for residents who reside there only for the winter season, thus causing additional expense for these residents when they are elsewhere. An internet connection would be even more expensive than a landline and no winter resident would implement the alarm conduit in this fashion, given a choice.

These circumstances have provided the motivation for the endeavor which led to the creation of the invention. The invention as presented dramatically reduces the recurring cost of maintaining the alarm conduit. The investment required is less than one year's recurring cost of the landline. Hereafter, the recurring cost is a fraction of the landline recurring cost.

Additionally, the invention results in a more secure system, as there are no telephone lines to be cut or internet outages to contend with.

The XP-600 system documentation is provided in paragraph 7, Brief Description of the Several Views of the Drawing and Appendix A, FIG. 2.

### BRIEF SUMMARY OF THE INVENTION

The fundamental function of the invention is to provide a more cost effective reporting conduit method for the alarm system. This is accomplished by utilizing a cell phone and cell socket technology in a unique configuration which is the essence of the invention. The cell phone is basic, and low cost. Service for the cell phone is provided by the pre-paid option which is very small compared to monthly landline charges and can be a onetime charge. The pre-paid option can be restored if and when a large number of alarm messages are generated and the need arises.

The invention configuration includes an UPS (Uninterruptable Power Supply) which insures system operation when a power failure occurs.

The invention is more secure than a landline implementation or internet connection as it is immune to tampering of these devices. Further the implementation can be hidden from view from intruders.

### BRIEF DESCRIPTION OF THE SEVERAL VIEWS OF THE DRAWINGS

See Appendix A, Drawings. FIG. 1 is an overview of the invention in block diagram form. It shows how the Home Alarm System output is configured so that the cell phone may be used instead of a land line, to report an alarm sequence to the monitoring operation.

FIG. 2, Appendix A, Drawings, the XP-600 wiring diagram, is shown to illustrate where the Alarm Sequence signaling is available to be connected to the cell phone system. The Alarm Sequence signaling is available at pins 16 and 17, and designated as “TELCO” in the right corner of the diagram.

### DETAILED DESCRIPTION OF THE INVENTION

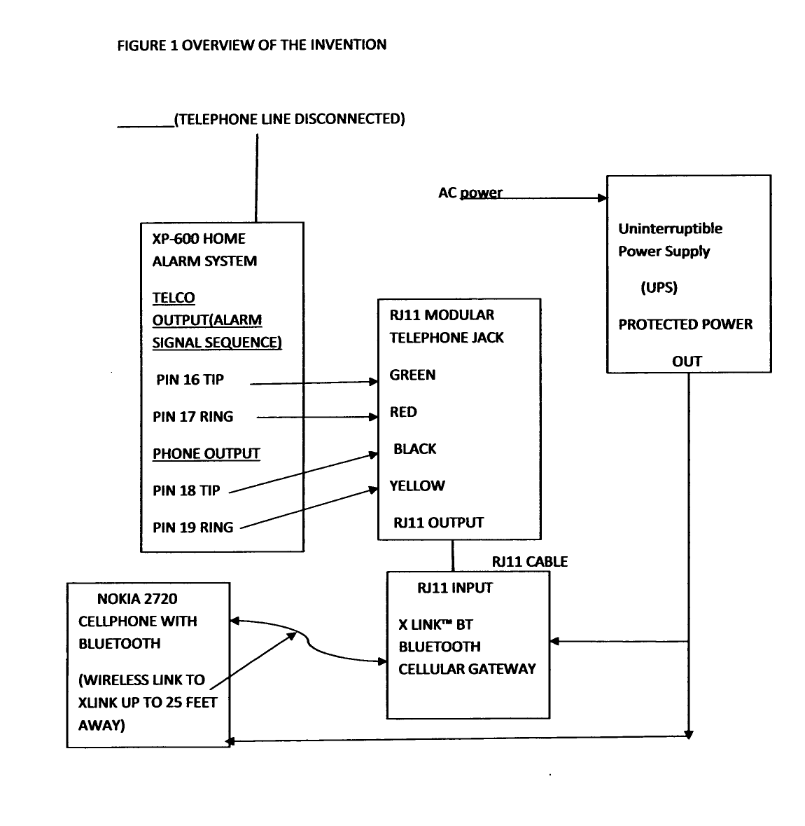

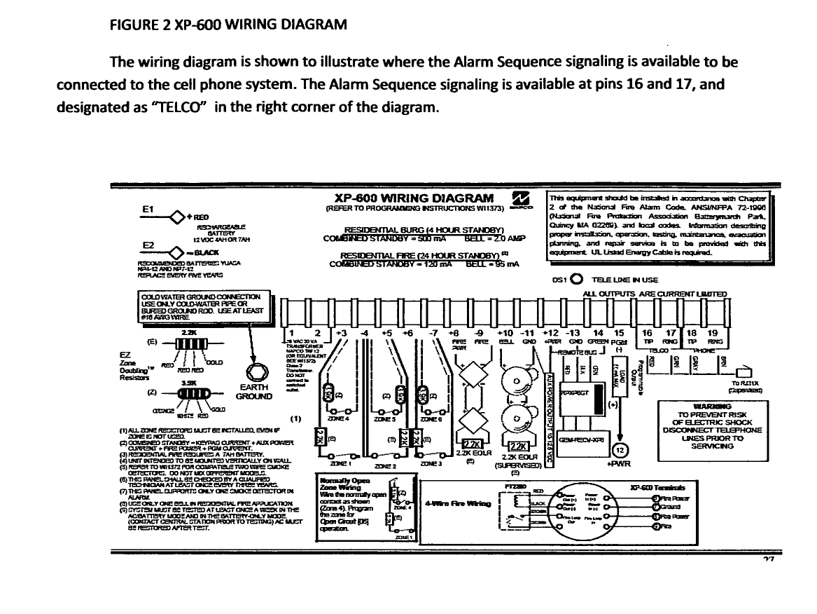

The purpose of the invention is to remove the need for a telephone landline and replace it with a cell phone connection for the purpose of signaling and reporting an alarm signal sequence to the alarm monitoring company in the event of an alarm triggering event. This is accomplished by connecting the alarm signal sequence which is available at output pins 16 and 17 and designated “TELCO” (Appendix A, FIG. 2, top right hand corner) and wiring them into the input connection of the cellular gateway, Appendix A, FIG. 1. This is accomplished by using an RJ11 modular jack to connect the wires to the RJ11 input of the cellular gateway The cellular gateway transmits this sequence by way of a wireless connection (Bluetooth) to the Nokia 2720 cell phone, which is equipped with a Bluetooth capability. The alarm sequence consists of the telephone number for the alarm monitoring company followed by identification information regarding the alarm type and intrusion information.

A modular telephone jack is used to translate the alarm signal into a form which can be used as a signal input into the gateway, namely an RJ11 cable input required by the cellular gateway. The cellular gateway is designed to handle standard telephone signaling which is what is provided by the alarm system output. The cellular gateway converts the telephone signals into signals compatible with the wireless Bluetooth connection to the cell phone. The cell phone may be located up to 25 feet away from the cellular gateway. The cell phone dials the alarm company number and transmits the alarm information.

The cell phone is configured in a ready or open mode ready to make a call. The cell phone is connected to its cell phone charger to insure a constant power source. The cell phone charger and the power source to the cellular gateway are connected to the UPS power supply to insure the system will operate and remain configured in the event of a power failure. The home alarm system itself also has an internal battery backup. The cell phone is configured to not accept any graphics or text input from any incoming calls. This insures that the Bluetooth connection is maintained. The cell phone is set up as a prepaid subscription. This arrangement is much less expensive than charges for a landline from the telephone company.

1. The invention makes it possible to operate standard home systems such as the Napco system without the need for a conventional landline telephone connection by using a unique configuration of standard components such as the cell socket and a cell phone as the alarm reporting device as described in paragraphs 6, 7 AND 8.
